(19) United States
(12) Patent Application Publication
(10) Pub. No.: US 2012/0028027 A1
(43) Pub. Date: Feb. 2, 2012

(54) Heat-Insulating Profile Strip for Window and Facade Components, Production Method and Moulding Tool

(75) Inventor: Gerhard Hortrich, Altensteig (DE)

(73) Assignee: BBG GMBH &CO.KG, Mindelheim (DE)

(21) Appl. No.: 12/867,840

(22) PCT Filed: Feb. 15, 2009
(86) PCT No.: PCT/EP2009/001047

§ 371 Date: Jan. 24, 2011

(30) Foreign Application Priority Data
Feb. 15, 2008 (DE) 10 2008 009 495.1

(51) Int. Cl. B32B 3/26; B32B 5/24; B32B 38/18; B29C 39/36; B29C 39/22

(52) U.S. Cl. 428/311.11; 428/304.4; 264/250; 156/245; 264/135; 156/66; 425/112

(57) ABSTRACT

The invention relates to a method for producing a high-temperature insulating profile strip (30) comprising a foamed insulating core (31) and an enclosure (32) surrounding the insulating core (31), with the following steps: forming the insulating core (31) by introducing a foam material into a first moulding tool; removing the insulating core (31) from the first moulding tool after hardening; introducing the insulating core (31) into a second moulding tool; injecting a casing material into the second moulding tool for forming the casing (32) surrounding the insulating core (31), and removing the profile strip (30) from the second moulding tool after the expiration of a hardening phase. The invention also relates to a moulding tool for carrying out said method and to a profile strip (30) produced according to said method.

The invention relates to a method for producing a profile strip with the pre-characterizing features of claim 1, a moulding tool for use in said method with the pre-characterizing features of claim 11 as well as a profile strip with the pre-characterizing features of claim 16.

Risen requests to the thermal insulation of new buildings and larger spread of passive houses lead to higher requests to the isolation values of windows and facade construction parts. Extreme low heat transfer values (U) of partially lower than 0.15 W (m²K) are achieved in passive houses by opaque fronts. Further improvement is possible by the use of vacuum insulation glass (VIG) with a heat transfer value U_{G} of 0.5 W (m²K) at a pane thickness of less than 10 mm. Problems still raise from conventional windows and facade constructions, since thermal or cold bridges are formed, particularly at window and door frames, which lead to significant heat losses. In order to overcome this, for example with the manufacture of conventional window sections, which usually consist of support structures made of aluminum or plastic (PVC), it was tried to fill out the cavities in the profile with open-porous insulating foam to reach an improvement of the insulation values. However, this affects the estimated improvements in the thermal insulation, achieved by the foaming, as compensated by transverse webs necessary for stabilization of the profile covering, since numerous thermal bridges are formed, which worsen the insulation values of the overall system significantly.

To solve this problem, DE 195 16 486 proposes window sections and windows, which include an outer shell made of hard integral foam and a core of isolating foam, wherein both the hard integral foam and the isolating foam originate from the same group of materials. Such profiles offer advantages with the material recycling, since no complicated separation of the components must be made. For manufacture, first the outer shell is produced, which is then filled with the isolating foam. A disadvantage of this manufacturing method is that stability-lowering cavities can be formed inside the profiles. Further, due to the prefabricated shell, it is not possible to insert additional elements, as for example stiffeners, into the profiles so that their use is limited and sufficient flexural strength is not ensured for greater profile lengths.

Thus, it is an object of the present invention to provide a method in that profile strips with low heat transfer values are prepared in a simple manner and necessary modifications of the mechanical stability of the insulating core can be performed during the manufacturing process. Another object of the present invention is to provide a moulding tool for carrying out the method as well as the profile strips prepared thereby.

This object is achieved by a method according to claim 1, a moulding tool according to claim 11 and a profile strip according to claim 16. Favourable embodiments of the invention are subject matter of the dependent claims.

The method according to the invention includes several steps for producing a profile strip with a foamed insulating core and an enclosure encapsulating the insulating core. First, introducing a foam material into a first moulding tool forms a foamed insulating core. Due to its open porosity, compared to a massive material core, very good insulating characteristics are achieved with low weight. After the cure or hardening of the insulating core it is taken out of the first moulding tool and subsequently transferred to a second moulding tool. The second moulding tool serves for production of the relative hard casing around the insulating core with a pourable material of higher density, respectively smaller porosity. This enclosure forms the solid, closed-porous surface of the profile strip after complete cure and improves mechanical stability as well as insulating characteristic. The encapsulating enclosure of the insulating core is produced by injection a shell material into the second moulding tool. Therein, for example a spray-casting tool is frontally attached at the second moulding tool and the shell material is subsequently pressed into the mould cavity. Due to its flow characteristic and the cross section of the second mould cavity the shell material puts as uniform layer around the insulating core. The step of removal of the profile strip from the second moulding tool forms the conclusion of the method after a hardening phase. The length of the second hardening phase depends on adjustment of the product characteristics of the shell material, for example is about 20 and 60 seconds.

It is pointed out that the aforementioned steps can be performed in a type of continuous process wherein rapid-hardening materials are processed in a manner of co-extrusion. Here, the second moulding tools can be formed like matrices. For a straightforward manufacturing process and easy recycling after the product cycle it is recommendable to form the foamed insulating core and the enclosure from uniform materials. In particular, the foamed insulating core and the enclosure consist of polyurethane. Polyurethane is particularly suitable due to the excellent thermal insulation values in the foamed state, high stability and mechanical resistance on use as shell material, enclosing the core of the profile strip. Thus, a profile strip can be manufactured with relative low material cost, that is mechanically stable, but lightweight, at very low heat transfer. Another advantage of polyurethane is that the foaming behaviour as well as the hardening time of the material problem can be adjusted, so that the foaming procedure can be matched with high throughput in the manufacturing process.

A favourable development of the invention includes placing at least an insert in the first moulding tool before injecting the foam material, in particular a stability increasing fiber reinforcement, a tube of plastic or of fiber-reinforced material or a fitting part. Such a modification of the insulating core is not feasible with the conventional methods for producing corresponding profile strips, because such inserts have to be prepared with the sheath of the profile. In contrast thereto, the present method allows placing of such inserts in or at the insulating core before the entry of the foam material into the first mould cavity and is already arranged at a predefined location before forming the enclosure. Thus, an adverse breaking of the enclosure is not required for subsequent fitting of inserts or fitting parts, such that tightness and thermal insulation can be improved.

In order to prevent a de-centering of the insulating core when injecting the shell/enclosure material into the second moulding tool, positioning spacers are employed for the centering of the insulating core. These positioning spacers can be formed on the insulating core, f. i. by pits in the first mould cavity, such that the foaming procedure provides projections, noses, cams or circumferential strips on the insulating core. Another favourable embodiment of the invention provides an arrangement of the positioning spacers in the second forming tool. They can be provided as centring strip or applied strip in the mould cavity in the attachment range of the foaming tool to prevent a change of position of the insulating core in the tool. Also favourable is sticking of the positioning spacers at the insulating core after its removal from the first moulding tool. The positioning spacers can be made of different materials as the insulating core and are for example shaped as round head nails or other plug elements from polycarbonate or other plastics to be inserted into or glued onto the insulating core in an intermediate step of the method.

The highest stability of the profile strip and the longest durability of the products, as for example window frames or facade systems, is achieved by an intimate compound of the shell material as enclosure and of the insulating core. A favourable embodiment proposes an additional process step after the removal of the insulating core from the first moulding tool, wherein a surface treatment of the insulating core is performed. This surface treatment will prepare the insulating core in an optimal way for the following coating with the shell material. A preferred surface treatment is grinding or sandblasting. A simple possibility of the surface treatment represents the moulding or spraying of the insulating core with a primer solution, which serves as coupling agent between the material surfaces.

In order to strengthen the insulating core formed in the initial steps of the method and to increase the torsion stiffness of the finished profile strip it is recommendable to envelope the insulating core with tape-like reinforcing material before the insertion into the second moulding tool. In particular, a fiber mat from carbon fibers, aramide or glass fibers is suitable. It's also possible to stiffen the edge connections of the profile strip, for example within the range of edges by fitting parts, at the joints or at receptacles of the profile strip formed as facade components or other supporting components. It is of substantial importance that fitting parts such as hinge strips or corner bands can be directly bonded on the enclosure, replacing 10 to 20 screwing points as otherwise required with conventional window sizes.

Of further inventive importance is a moulding tool, which is suitable for the use in the above-described method. This moulding tool includes a first mould cavity for forming a foamed insulating core and second mould cavity for forming an enclosure surrounding or enveloping the insulating core. According to the invention the second mould cavity is a bit larger as the first mould cavity, namely about the wall thickness of the enclosure. The moulding tool is divided in two parts, wherein it is also possible to arrange a first and second mould cavity separately in order to form first the insulating core, to pass this to the second mould cavity to be subsequently coated with the material forming the outer enclosure. It is also possible to provide further processing stations between first and second mould cavity (e.g. a grinding or sandblasting station or a dipping bath for the primer) for modifying the insulating core surface or for the attachment of positioning spacers.

Advantageously, a connection means for a foam head is provided at the first mould cavity, whereas an adapter for coupling a mixing head is arranged at the second mould cavity. It is also possible to attach the foam head at a robot arm and to fill the initially opened first mould cavity in its whole length with the foam material. The adapter for coupling the mixing head is preferably arranged frontal at the second mould cavity. Thus, a uniform distribution of the shell material can be achieved, ensuring a defect-free casing of the insulating core by pressurized injection of the shell material.

It is favourable, when the first mould cavity has an attachable or pivoted cover plate. This is fitted on the mould cavity after filling with the foamable insulating material to form the core due to chemical conversion processes. With the industrial manufacture of the insulating cores the closing of the mould cavity can be automated. Adequate adjustment of the foam parameters achieves a short time frame for the foaming and subsequent hardening of the insulating core material, wherein the hardening process takes place in the completely closed tool.

In order to avoid a de-centering of the insulating core in the second, larger dimensioned mould cavity and therewith a non-uniform enveloping/encasing of the insulating core, it is favourable to provide positioning spacers for the insulating core in the second mould cavity. The positioning spacers can be provided by positioning pins or fillets, that are allocated over the cavity and are inserted or moulded-in the nest walls. It's also possible to additionally arrange fillet-wise or punctiform spacers at the moulding cavity to ensure the positioning of the inserted work piece. This is in particular applicable for shorter profile strips.

According to present invention as described above, the positioning of an insert in the isolating core is also possible, f. i. to provide positioning spacers in the first mould cavity for positioning an insert within the insulating core. Such inserts can be a stability increasing fiber reinforcement, a tube made of plastic or fiberglass or a fitting part. Thus, the stability-increasing fiber reinforcement is supported in the mould cavity, f. i. by a front pin and a rear pin for the tube made of plastic or fiberglass or the fitting part is placed in an embracing recess. Thus, the insert is positioned before foaming of the insulating core material starts.

As to the automation of the manufacturing method it is possible to arrange the respective mould cavities on a revolving device for filling via a robot head automatically.

After the curing time automatic removal and further transport to the carrier for an appropriate number of second mould cavities for formation of the enclosure is likewise performed by automated setting the mixing head and injecting the enveloping material.

A thus produced profile strip according to the invention consists of a foamed insulating core and an envelope/enclosure surrounding the insulating core, wherein the insulating core and the envelope are preferably made of similar materials, in particular from polyurethane. The profile strip is characterised in that the insulating core includes foamed-in insert, in particular a stability increasing fiber reinforcement, a tube made of a resin or fiberglass and/or a fitting part. The insert is incorporated on the preparation of the isolating core of the profile strip in the first moulding tool by foaming and then completed by enveloping this insulating core. It's also possible a fitting part of a window attachment is glued and secured via a screw, which intervenes in the tube of the foamed-in insert the profile strip. To ensure a still better connection between a screw and tube a bore can be provided in the profile strip to spreading pegs or comparable holding elements in the tube, which forms a receptacle for the screw. Such a construction allows even the attachment of heavy facade components at the profile strip. If the insert is formed as tube inside the profile strip, this can also serve as a corner reinforcement for frame structures formed from the profile strip. For this purpose elbows are inserted into the frame parts before sticking together. It's also possible, that the inserts are formed as single fibers or fiber strands to be inserted into the insulating core, in order to stiffen the entire moulding.

It's favourable if the insulating core of the profile strip has a multiplicity of positioning spacers. This ensures that the envelope or enclosure has the same thickness at all locations of the profile strip, i.e. a uniform envelope of the foamed core is achieved as de-centering of the insulating core in the mould cavity is prevented. Preferably, these positioning spacers are simply stuck into the insulating core. In addition, projections or strips can be formed with the formation of the insulating core in the moulding tool or corresponding cams can be subsequently glued onto the insulating core surface. The positioning spacers can be formed as noses or cams at the insulating core to provide exact centering of the workpiece in the moulding tool, wherein the noses or cams are successive compressed by the injection pressure of the enveloping material to form a uniform wall thickness of the enclosure in the second mould cavity. This centering can be improved by using positioning spacers in the second mould cavity, as well. It's also possible to insert nails made of polycarbonate or other plastics into the insulating core, which are then over-laminated on forming the envelope with the injected shell material.

A favourable embodiment of the profile strip includes wrapping of the insulating core with a sheet material before enveloping with the coating or skin material in order to stiffen or reinforce the entire workpiece at least partially. For example, fiber mats of carbon fiber, fibreglass, aramide or cotton fabrics can be used for wrapping. Preferably, wrapping of the insulating core with corresponding cut material sections followed by application of a vacuum method. Thus, the fiber mats can be bonded to the insulating core bonded or fixed by nails provided as positioning spacers. It is also possible that the material of the envelope penetrates into the fiber mat and connects thereto, so that further strengthening is achieved.

It's preferred to coat the profile strip on its outside with UV-stable paints or with a film as additional envelope. The film can be placed in the foaming mould before introducing the foaming material or can be applied to the finished profile strip, f. i. to colour the profile strip. The film can also form a primer as basis for the paintwork.

Further advantages and features of the invention result from the subsequent description of preferred, but non-limiting embodiments of the invention on the basis schematic drawings. They show in:

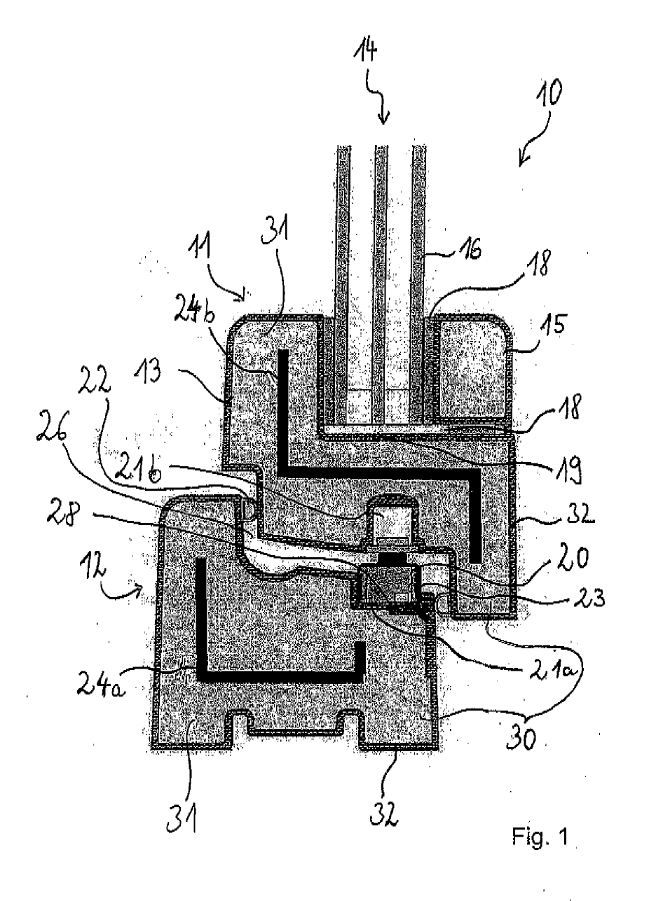

FIG. 1 a preferred embodiment of a profile strip for use in a window,

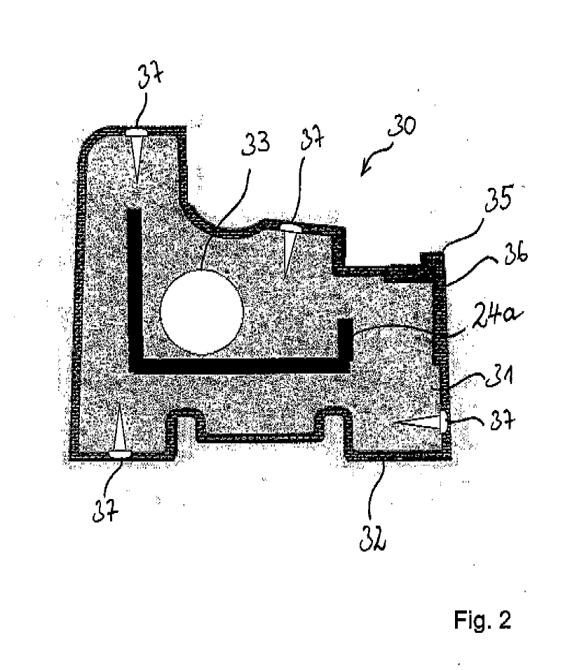

FIG. 2 another preferred embodiment of a profile strip in sectional view,

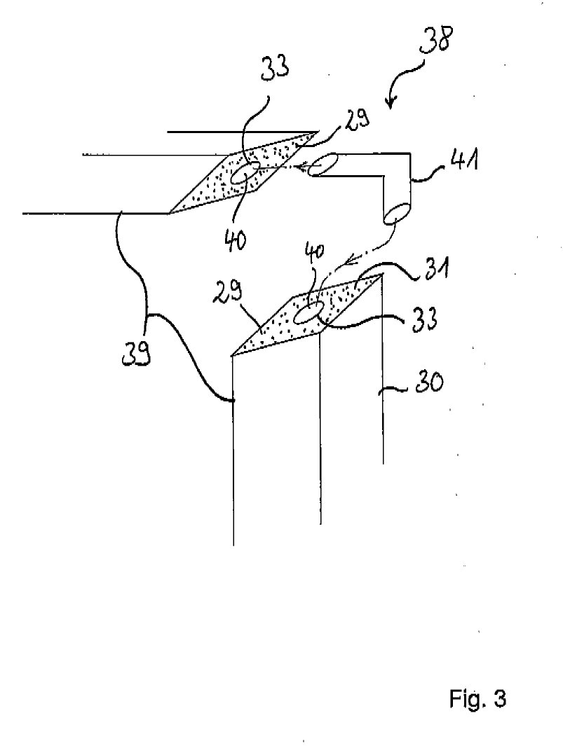

FIG. 3 an edge connection of two profile strip sections in perspective view,

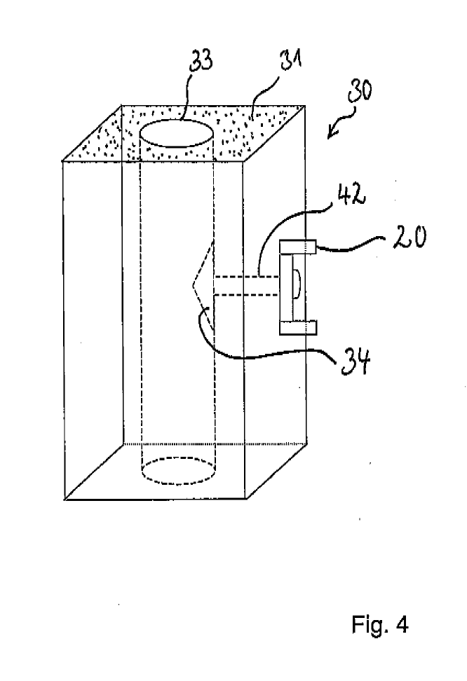

FIG. 4 a preferred embodiment of a profile strip section in isometric representation, and

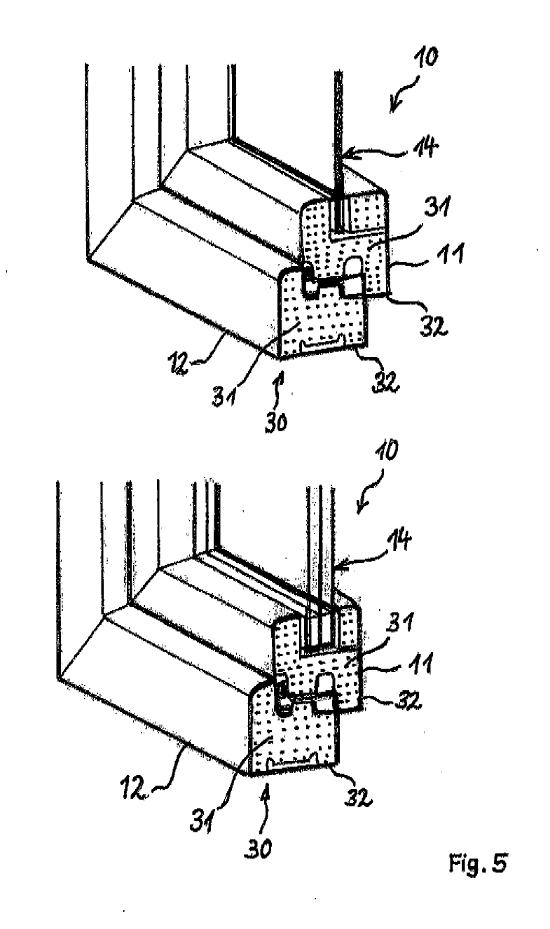

FIG. 5 part of two window variants in perspective view, formed from the profile strip.

FIG. 1 shows a section of a window 10, whose window wing 11 and window frame 12 are made of a profile strip 30 according to the invention. The profile strip 30 can be manufactured in fixed, prolonged lengths of 3 to 6 metres, for example, and cut according to desired length of the window dimension. The manufacture can be also made with profile strips 30 having the dimension of the window. The window frame 12 is fixed in a building opening and holds the window wing 11 via corresponding fitting parts 20. The window wing 11 consists of two profile parts 13, 15, i.e. the actual wing framework 13 and a retaining bar 15, which is mounted after insertion of a glazing 14, in this embodiment a triple insulating glazing. The glazing 14 includes three parallel panes 16 and additional sealing elements 18 are applied at joints 19 on the wing frame 13, then the retaining bar 15 is fixed to the outer pane 16 and bonded to the wing framework 12. In this embodiment the window wing 11 and window frame 12 consists completely of foamed polyurethane, wherein the profile strip 30 is formed by an insulating core 31 prepared in a first mould cavity (not shown), which is subsequently coated after the insertion into a second mould cavity (not shown) with a rigid enclosure or envelope 32 also of polyurethane. On manufacturing the profile strip 30 recesses 21a, b provided in the frame or the wing are produced as well, in order to fix fitting parts 20, f. i. bolting devices by bonding. To stabilize the recesses 21a, b the profile strips 30 can be made thicker at those positions; however, as indicated in FIG. 1, it is also possible to reinforce the recesses 21a, b at these force introduction points 23 by additional inserts 28 in the profile strips 30 without thickening in order to prevent rupture of the fitting part 20 by tension or compressive forces. In this embodiment a fiber mat made of carbon fiber is applied to the corresponding locations of the insulating core 31 before foaming the rigid envelope 32 around the core 31. As indicated above, bonding of such fitting parts together with the envelope 32 is substantially easier than conventional bolting with a dozen or more screws.

It's also possible on manufacture of the profile strip 30 to fix the fitting part 20 and inserts 28 in the first mould with the formation of the insulating core 31 and coating these parts with the envelope 32 by foaming, so that such an inner fitting part 20 is invisible and only locking bolts or similar fitting parts pass through the envelope 32. This can be favourable from aesthetic reasons, but anchoring can be improved, as well.

In order to prevent thermal cold bridges on contact of window wing 11 and window frame 12, these two frame members 11, 12 are spaced by a gap 26, which is closed to the outside and inside by conventional rubber seals 22. For reinforcing the entire profile strip 30 its interior has essentially U-shaped or S-shaped rails 24a, b. These rails 24a, b are inserted before foaming of the insulating core 31 in a similar way as the above described inserts 28, such that they are thermally protected. In order to lower heat conduction and to improve the insulation value of the frame structure, the rails 24a, b of this embodiment are made of carbon fiber reinforced resin or fiberglass.

Thus, window systems with slender frame structures and high-efficient glazing can be made from the profile strip 30, which form a thermal and static unit. In the embodiment, a triple insulating glazing is used; by using vacuum insulation glass (VIG) the framework of the corresponding windows can be further slimmed with improved U_{G}-values of the window frames 12.

FIG. 2 shows the sectional view of another preferred embodiment of the profile strip 30 according to the invention. This embodiment includes a stiffening rail 24a and additionally a tube 33 embedded in the insulating core 31, such that this profile strip 30 can be used as carrier for facade components including a guide for cables or lines or as receptacle for spreading pegs 34 used in the profile (cf. FIG. 4). Beside the inserts 28 of the profile an additional stiffener in the insulating core 31 is formed at the right upper end of the corner edge 35. This stiffener is formed by a carbon angle profile 36 fixed to the insulating core 31 before coating it with the envelope or skin material 32, wherein heat insulating properties of the profile strip 30 are not decreased. FIG. 2 further shows positioning spacers 37 which are inserted into the insulating core 31 before the formation of the envelope 32, thus preventing an excentric position when forming the envelope 32 by coating the insulating core 31 with the shell material in the second mould, such that a uniform wall thickness of the envelope 32 is ensured. The positioning spacers 37 are in this embodiment polycarbonate nails which remain in the insulating core 31 and are slightly covered by the shell material of the envelope 32, such that they are invisible on the finished profile strip 30.

FIG. 3 shows a variant of forming a highly stable edge connection 38 for the construction of window frames 12 made of the profile strips 30. The profile strip 30 includes in this embodiment an additional carbon fiber reinforced tube 33 foamed-in the insulating core 31. When the profile strip 30 is cut to miter a circular sleeve 40 is formed across the profile section. Before connecting those frame parts 39 of the formed strip 30 made of polyurethane and sticking together the cut surfaces 29 an elbow 41 of smaller diameter in the comparison to the carbon tube 33 is bonded into the sleeve 40 formed by the tube 33, thus reinforcing the edge connection 38 of the window frame 12. In this way, even large frameworks with high strength can be formed.

FIG. 4 shows another use for a tube 33 incorporated inside the insulating core 31. This serves for guidance of cables and in this embodiment as abutment for a spreading peg 34 inserted via a bore 42 into the profile strip 30 in order to fix for example fitting parts 20 or other mounting plates to the profile strip 30. Mounting of facade components or of other laminar structures to the profile strip 30 is also possible. Thus, a peeling-off of the fitting part 20 is safely prevented, in particular when two spreading pegs 34 are employed.

FIG. 5 presents two embodiments of windows 10 made from the profile strip 30. The lower variant shows a window with triple insulating glazing 14, while in the upper variant a vacuum insulating glazing 14 was used. Both variants offer substantial advantages over conventional window constructions. As the window frames 12 and window wing 11 are both made of the profile strip 30 including the insulating core 31 with a coated envelope 32 a profile is formed without transverse webs and thus without cold bridges in contrast to foaming a conventional hollow profile. Further, no stability-reducing cavities exist due to the subsequent envelope 32 around the insulating core 31. In this embodiment, having a width of only 90 mm the window 10 shows a heat transfer value U_{f}+U_{g} for the window frame 12 and the glazing 14 of <0.8 W/(m²K) and is thus appropriate for the use in building of passive houses as required value.

### REFERENCE SYMBOL LIST

10=window
11=window wing
12=window frame
13=wing frame
14=glazing
15=retaining bar
16=pane
18=sealing element
19=joint
20=fitting part
21a, b=recess
22=sealing section
23=force introduction point
24a, b=rail
26=gap
28=insert
29=cut adhering surface
30=profile strip
31=insulating core
32=enclosure/envelope
33=tube
34=spreading pegs
35=end edge
36=carbon angle profile
37=positioning spacer
38=edge connection
39=frames
40=sleeve
41=elbow
42=bore

1. Method for producing a profile strip (30) comprising a foamed insulating core (31) and an enclosure (32) surrounding the insulating core (31) with the following steps:
forming the insulating core (31) by introducing a foam material into a first moulding tool,
removing the insulating core (31) from the first moulding tool after hardening,
inserting the insulating core (31) into a second moulding tool,
injecting an enveloping material into the second moulding tool for formation of the enclosure (32) surrounding the insulating core (31), and
removing the profile strip (30) from the second moulding tool after a hardening phase.

2. Method according to claim 1, characterised in that the foamed insulating core (31) and the enclosure (32) consist of similar materials.

3. Method according to claim 1 or 2, characterised in that the foamed insulating core (31) and the enclosure (32) consist of polyurethane.

4. Method according to one of claims 1 to 3, characterised in that before introducing of the foam material at least an insert (28), in particular a stability-increasing fiber reinforcement, a tube (33) made from plastic or fiber-reinforced material or a fitting part (20) is placed into the first and/or second moulding tool.

5. Method according to one of the preceding claims, characterised in that positioning spacers (37) are provided for centering of the insulating core (31).

6. Method according to claim 5, characterised in that the positioning spacers (37) are formed on the insulating core (31).

7. Method according to claim 5, characterised in that the positioning spacers (37) are arranged in the second moulding tool.

8. Method according to claim 5, characterised in that the positioning spacers (37) are mounted at the insulating core (31) after removal of the insulating core (31) from the first moulding tool, in particular inserted or glued.

9. Method according to one of the preceding claims, characterised in that a surface treatment of the insulating core (31) is performed after removing of the insulating core (31) from the first moulding tool (31), in particular grinding, sandblast or immersion into a primer solution.

10. Method according to one of the preceding claims, characterised in that before the insertion of the insulating core (31) into the second forming tool an envelope (32) of the insulating core (31) with a tape-like reinforcing material, in particular a fiber mat, is provided, wherein fitting parts (20), in particular hinges are glued-on in this range after hardening the envelope (32).

11. Moulding tool, in particular for the use in the method according to one of claims 1 to 10, characterised by a first mould cavity for formation of a foamed insulating core (31) and a second mould cavity for formation of an enclosure (32), surrounding the insulating core (31), wherein the cross section of the second mould cavity is larger than the first mould cavity in a range of the wall thickness of the enclosure (32).

12. Moulding tool according to claim 11, characterised in that the first mould cavity has connection means for a foaming head and the second mould cavity has a receptacle for coupling a mixing head, preferably at the front.

13. Moulding tool according to claim 11 or 12, characterised in that the first mould cavity has a cover lid to be put thereon or pivoted.

14. Moulding tool according to one of claims 11 to 13, characterised in that positioning spacers (37) for the insulating core (31) are arranged in the second mould cavity.

15. Moulding tool according to one of claims 11 to 14, characterised in that at least one positioning spacer (37) is arranged in the first mould cavity for an insert (28) in the insulating core (31), in particular a stability-increasing fiber reinforcement, a tube (33) made from plastic or a fiber-reinforced material or a fitting part (20).

16. Profile strip (30) with a foamed insulating core (31) and a rigid enclosure (32), enveloping the insulating core (31), wherein the insulating core (31) and the enclosure (32) are made of similar materials, in particular of polyurethane and the profile strip (30) being produced by a method according to one of claims 1 to 10, characterised in that the insulating core (31) includes an insert (28) foamed therein, in particular a stability-increasing fiber reinforcement, a tube (33) from a resin or fiber-reinforced material and/or a fitting part (20).

17. Profile strip (30) according to claim 16, characterised in that the isolation core (31) has a multiplicity of positioning spacers (37).

18. Profile strip (30) according to claim 17, characterised in that the positioning spacers (37) are formed to the insulating core (31) or are inserted into the insulating core (31).

19. Profile strip (30) according to one of claims 16 to 18, characterised in that the insulating core (31) is coated with a tape-like reinforcing material, in particular a fiber mat.

20. Profile strip (30) according to one of claims 16 to 19, characterised in that the enclosure is painted with UV-stable paints or coated with a film.
